(19) United States
(12) Patent Application Publication
(10) Pub. No.: US 2007/0091717 A1
(43) Pub. Date: Apr. 26, 2007

(54) Device for dosing and mixing powdery materials

(76) Inventor: Kurt Steinwald, St. Polten (AT)

Correspondence Address: FULBRIGHT & JAWORSKI L.L.P., 600 CONGRESS AVE., SUITE 2400, AUSTIN, TX, 78701, US

(21) Appl. No.: 10/556,732

(22) PCT Filed: May 11, 2004
(86) PCT No.: PCT/AT04/00165

§ 371 Date: Aug. 22, 2006

(30) Foreign Application Priority Data
May 12, 2003 (AT) A 722/2003
Mar. 19, 2004 (AT) A 486/2004

(51) Int. Cl. B01F 13/10; B01F 15/02

(52) U.S. Cl. 366/141; 366/155.1; 366/156.1; 366/192

(57) ABSTRACT

The invention relates to a device for dosing and mixing powdery materials, said device comprising essentially horizontally adjacently arranged reservoirs for the starting materials, provided with a closing and dosing cap (27) on the lower side, dosing devices (12) for dosing the materials, and at least one mixing device (10) for mixing the dosed materials. At least one charge container (2) comprising a lid (13) on the upper side thereof and used to receive dosed quantities of initial materials is displaceably t-arranged beneath the reservoirs, the charge containers (2) being provided with a flap (14) on the lower side thereof. The aim of the invention is to create one such dosing and mixing device which is as flexible, expandable, and structurally simple as possible. To this ON end, the reservoirs are embodied as dosing containers (1) with integrated dosing devices (12). The invention also relates to a device for dosing powdery materials, comprising a reservoir provided with a closing and dosing flap (27) on the lower side, and dosing devices (12) for dosing the materials, the reservoirs being embodied as dosing containers (1) with integrated dosing devices (12).

The invention concerns a device for the dosing and mixing of powdery materials, comprising reservoirs for the starting materials arranged essentially horizontally next to each other, comprising a closing and dosing gate or the like at the lower end, and comprising dosing devices for dosing the materials, and comprising at least one mixing device for mixing the dosed materials, wherein beneath the reservoir at least one batch tank is movably arranged, comprising a lid at the upper end, to receive dispensed amounts of starting materials.

The invention moreover concerns a device for dosing of powdery materials comprising a reservoir comprising a closing and dosing gate or the like at the lower end, and comprising dosing devices for dosing of materials.

In many sectors of industry, such as the construction material industry, the chemical industry, the animal feed industry, but also the foodstuff industry and pharmaceutical industry, it is necessary to mix powdery materials in more or less precisely dosed amounts in order to obtain an intermediate product or an end product. For example, in the construction material industry, in order to make adhesives or the like one blends the respective powdery ingredients and additives and fills them into bags. Depending on the type of adhesive or the compensation mass, different mix ratios are required. For this purpose, all possible starting materials are usually kept available in corresponding containers. The size of the particular container will depend on the usual dosage of the starting material. Thus, powdery materials of large quantity and [requiring] rather low dosing precision will be kept in rather large containers, such as silos, while additives of moderate quantity and [requiring] moderate dosing precision will be kept in containers of moderate size, and finally additives of rather small quantity and [requiring] rather high dosing precision will be kept in small containers or bags. To make it possible to produce a desired product according to a specific formula from specific starting materials, a common dosing device is generally used, which is transported from one container to another, or to which the containers are connected in succession. It will be necessary, between dosing of different materials, to clean the dosing device, or else there will be unacceptable deviations from the formula. This is required, for example, in the chemical industry when dosing paint pigments, so as not to obtain the wrong color results. Changes in materials always entail very great expense.

A dosing device for powdery products is known, for example, from DE 197 28 624 C2, wherein each reservoir is coordinated with a dosing device, which doses the particular material into a tank scale. After this, the dosed powders are taken by pneumatic conveyors to an inspection scale and finally to a mixer. However, it is necessary at regular intervals to clean the conveyors, as well as the weighing devices, which substantially increases the expense of the method. Also, in the case of fine-grain heavy ingredients, mixture separation may occur during pneumatic conveyance.

A device for the dosing and mixing of powdery materials of the kind in question is known in the field of the foodstuff industry from DE 199 09 896 C2. In this case, one produces a mixture of friable materials in order to produce baked goods by dosing and mixing of the powdery components. The batch tanks are adapted to the different functions for receiving the mixed powder by replacing the lids. The transport lid is loosely placed on the edge of the tank. Such a device would not be suitable for the filling of especially delicate substances, as in the pharmaceutical industry. Furthermore, in order to empty the batch tank one must rotate it about 180 degrees, since this occurs through a funnel-shaped drainage lid.

DE 38 18 637 A1 shows a device for bringing together pourable material components into a mixture, wherein reservoirs for the starting materials are provided that are arranged essentially horizontally next to each other, having dosing worms flanged onto their bottoms, taking the materials to a respective weighing tank. From the weighing tank the dosed material is delivered via a pivoted tilting arm into a collecting tank arranged underneath. All components are dosed at the same time into the weighing tanks and then emptied one after the other into the collecting tank and thereafter taken on to a mixing operation. The reservoirs are firmly anchored and connected to supply lines, so that their replacement or a replacement of the product contained therein can be done only with great expense. Since the dosing and weighing devices are assigned to the individual reservoirs, when the reservoirs are replaced one must also replace or at least clean the dosing and weighing device.

DE 101 42 949 A1 shows a device for preparing a mixture from starting substances, wherein the reservoirs for the starting materials are arranged essentially horizontally next to each other and a collecting or batch tank is movably arranged beneath the reservoirs. In this design as well, dosing devices are assigned to the individual reservoirs. What is more, the collecting tank has no gate or the like at its lower end, so that an emptying of same is possible only by a costly 180-degree turning.

Finally, DE 38 16 202 A1 shows a layout design for the production and packaging of a multicomponent mixture, in which reservoirs for the starting materials are arranged essentially horizontally next to each other, and a dispensing, weighing and transfer device is arranged under each of them. Tanks are movably arranged beneath the filling stations in which the individual components are dosed. The transfer process from the weighing tanks occurs by a relatively costly 180-degree turning movement of the weighing tank.

The problem of the present invention consists in creating a dosing and mixing device as indicated above, as well as a dosing device that is as flexible and as expandable as possible, and furthermore has the simplest possible construction. Moreover, when a change occurs in the makeup of the mixture, the fewest possible number of components should require cleaning, so that the dosing and mixing process does not have to be interrupted for too long. Finally, a quick and precise dosing should be possible, and the dosing and mixing should be automated as much as possible.

The problem is solved by an above-indicated dosing and mixing device, wherein the reservoirs are configured as dosing tanks comprising integrated dosing devices. Such a configuration of the reservoirs and batch tanks of the dosing and mixing device achieves an optimal and automatable filling and emptying of same. A costly manipulation of the tanks for emptying them, e.g., by turning them 180 degrees, is not necessary on account of the gate or the like at the lower end of the batch tank. The dosing and mixing device in question is distinguished by an especially low structural height, since the components are arranged essentially next to each other. This arrangement also enables a simple and quick expansion. In contrast, present-day dosing and mixing layouts often have an especially high structural height, since the reservoirs are arranged above the weighing and mixing equipment with a stationary weighing tank placed underneath, connected to the dosing tanks by dosing equipment. Such a vertical layout is usually limited, so that an expansion to new starting materials and thus a changing of the formula involves great expense. In the known dosing and mixing devices, dosing equipment is usually coordinated with small silos and, like them, has a stationary construction, or, less often, stationary dosing equipment is also coordinated with flexible tanks. Usually, however, the dosing equipment is suitable for only one unchanging raw material. A changing of the formula entails very high expense, usually involving a complete disassembling and cleaning of the component parts. A product change in the mixing and dosing layout of the invention can be done by quick replacement of the entire reservoir, configured as a dosing tank with integrated dosing equipment, without cleaning expense. At a later time, the removed reservoir or dosing tank can be integrated back in the mixing and dosing layout, so that the layout can be quickly and easily adapted to changing formulas. This is of great importance, especially for complicated and short-lived formulas, and also when there is an increasing number of raw materials. The dosing equipment is preferably constituted by dosing worms.

Advantageously, covers are arranged at the upper ends of the dosing tanks, so that they can be replaced automatically or manually.

According to another feature of the invention, the gates or the like of the batch tanks and possibly the closing and dosing gates or the like of the dosing tanks can be activated automatically. In this way, an automated mixing of the powdery materials can occur.

It is likewise beneficial that the covers of at least the batch tanks and, in any case, also the covers of the dosing tanks can be automatically activated. The automatic activation can be done pneumatically or electrically.

According to another feature of the invention, at least one collecting funnel is arranged underneath one or more dosing tanks for collecting at least one starting material. The collecting funnel can be arranged precisely underneath a dosing tank and the starting material of this dosing tank can be collected accordingly before being passed on to the batch tank. It is likewise possible, for example, to arrange the collecting funnel underneath several dosing tanks and to pass the starting materials of these dosing tanks one after another via the same collecting funnel to the respective batch tank.

Advantageously, a filling head is connected to the collecting funnel at the lower end for filling the batch tank. This filling head is docked at the cover of the batch tank and thus enables a dust-free filling of the batch tank with the starting materials located in the collecting funnel.

The filling head can have a device for activating the cover of the batch tank being filled, so that when the filling head docks at the upper end of the batch tank the cover can be automatically activated. This can occur purely mechanically, but also pneumatically, hydraulically or electrically. A construction with a turning and swiveling movement of the cover is especially suitable for manipulation of the cover.

The collecting funnel can contain a weighing device, by which the material dispensed into the batch tank can be weighed. Various designs are possible for the weighing device. The weighing device provided in the collecting funnel, or the collecting funnel configured as a weighing device serves, in particular, for fine dosing of a very small quantity of material with the utmost precision.

It is likewise possible to provide weighing frames on which the dosing tanks can be placed. The dosing by means of weighing equipment arranged in such weighing frames underneath the dosing tanks or integrated into the dosing tanks usually represents the normal situation. In this way, the material of the dosing tanks can be weighed out in medium quantities and with medium precision by a subtractive weighing. The data put out by the weighing equipment can be relayed by wired or wireless means to corresponding control mechanisms.

Advantageously, the dosing tanks, which are also arranged essentially horizontally next to each other, are also arranged so that they can move along a predetermined path. In this way, on the one hand, a replacement of empty dosing tanks becomes possible and, on the other hand, a changing of the starting materials for changing formulas is quickly and easily possible. Likewise, the dosing tanks can be moved along a path to replenishing stations.

For large components that are supplied in large amount and with rather low dosing precision, large silos and conveying and dosing equipment can also be provided for mixing these large components into the batch tank or collecting funnel. These large silos with greater volume than the dosing tank can be placed next to the layout and be connected to the collecting funnels, for example, by worm conveyors.

Furthermore, devices can be provided for manual mixing-in materials that are configured essentially identical in design to the dosing tanks and possibly to the batch tanks, providing an opening for the mixing-in materials. This device for manual mixing-in materials can be incorporated in the dosing and mixing device, just like normal dosing tanks, with the sole difference being that the materials being mixed in are placed by hand into the opening. Likewise, these devices for manual mixing-in materials can also be arranged above the dosing tanks, and in this way certain materials can be placed by hand into the dosing tanks. The opening can be arranged at the side, so that it is easily possible add the materials, for example, from bags.

It is likewise advantageous for the dosing tanks to contain stirring mechanisms. Such stirring mechanisms preferably serve to remove all materials located in the dosing tank without a trace, so that essentially no material remains in the dosing tank. For this purpose, the dosing tank is preferably configured flat at its lower end.

According to another feature of the invention, the movement paths of the batch tanks and/or the dosing tanks are composed of individual elements that have conveying mechanisms, preferably rollers. Thanks to such a modular construction, a modification of the dosing and mixing device or an expansion can be done especially quickly and easily. Instead of building the movement paths with rollers, systems with chain conveyors are also conceivable.

Individual elements of the movement paths can pivot, in order to accomplish a change in direction of the batch tanks and/or dosing tanks being delivered along the movement paths. Also, when the movement paths are composed of chain conveyors, chain conveyor tables can be provided. It is likewise possible to transport the batch tanks and/or the dosing tanks suspended along a movement path. For this, the batch and/or dosing tanks are outfitted with an appropriate design on their top side, which rests against a so-called overhead conveyor. Such an overhead conveyor can be designed as a roller or pulley train driven at one or both ends, or a chain conveyor. Such a design advantageously frees up floor space.

When elements of the movement paths contain weighing devices, the filling of the batch tank or dosing tank located at the particular element can be weighed and thus the quantity of the added material can be adjusted.

Advantageously, a transport device such as a crane is arranged above the dosing tank for the moving of the dosing tank or for the positioning of replenishment containers. This enables a quick replacement of dosing tanks and, thus, a quick adapting of the layout to altered circumstances.

The dosing tanks and/or the batch tanks are preferably formed from a tank that is arranged inside a frame. The frame confers the necessary stability on the dosing tank or batch tank and, moreover, offers possibilities of manipulation.

Especially in the case of the batch tank, the tank has a downward-tapering funnel shape. Thanks to this, the powder located inside is guided toward the gate at the bottom of the batch tank.

The tank and frame preferably have rectangular horizontal projections. In this way, it becomes possible to arrange several dosing tanks or batch tanks in a row, making optimal use of the space.

If openings are provided at the bottom of the frame to accommodate the forks of a forklift truck or the like, the dosing tank and the batch tank can be easily transported with a corresponding forklift truck or the like.

As an alternative or in addition to this, the dosing tank and/or the batch tank can have openings at their tops for insertion of a hoisting mechanism. This makes it possible to handle them by means of a crane.

Advantageously, four suspension devices are provided at each corner of the top side of the dosing tank and/or the batch tank. This enables lifting the dosing tank by means of an appropriately configured X-shaped or rectangular lifting implement, without the risk of the dosing tank swaying back and forth. In this way, a precise setting-down is possible. This, in turn, facilitates a fully automatic operation of the dosing and mixing layout.

If both the dosing tank and the batch tank have identical outer dimensions, the flexibility will likewise be enhanced, since the dosing tank and batch tank can be exchanged for each other, if necessary. Only the dosing equipment located in the dosing tanks is not usually contained in the batch tank.

In order to enable a lifting of the dosing tank or batch tank, or a lowering of same, a lifting mechanism for lifting the dosing tank and/or the batch tank can be provided, integrated along the movement path of the dosing tank or batch tank. This lifting mechanism can be outfitted with forks, for example, in the manner of a forklift truck, which engage with the aforementioned openings at the bottom of the frame of the dosing tank and/or the batch tank.

For especially high flexibility, the lifting mechanism can be rotated 360 degrees.

For a partial operation or fully automatic operation, it is advantageous for at least the batch tank and possibly the dosing tank to have devices for identification. These can be formed, for example, by barcodes, which can be sensed by corresponding reading devices, or also by integrated circuits, which can be polled by corresponding transponders.

According to another feature of the invention, the batch tank and possibly the dosing tank have interfaces for connection to a control mechanism. These interfaces enable a polling of weighing devices in the batch tanks and possibly the dosing tanks, but also an activation of mechanisms located therein, such as mixing devices, dosing devices, or opening mechanisms for the cover or the gate.

Furthermore, it is advantageous for the batch tank and possibly the dosing tank to have mechanisms for connection to an electrical voltage supply, a pressurized air source, or the like, especially plug and socket connections. Through these plug-and-socket connections or slip-ring connections, the batch tank and possibly the dosing tank are supplied with the necessary energy at their corresponding positions, so that an operation of the dosing device or mixing device as well as an automatic opening and closing of the cover and the gate becomes possible.

It is advantageous in a fully automatic operation for the batch tanks to be able to move along an essentially closed path.

The problem is also solved by an above-indicated dosing device, wherein the reservoirs are configured as dosing tanks with integrated dosing devices. Thanks to such a configuration of the reservoirs, an optimal emptying of same becomes possible. A costly manipulating of the tanks for emptying them, for example, by turning them 180 degrees, is not necessary. A changing of product in the dosing device according to the invention can occur by quick replacement of the entire reservoir, configured as a dosing tank with integrated dosing equipment, with no cleaning expense. At a later time, the removed dosing tank can be integrated into the mixing and dosing layout once again, so that the layout can be quickly and easily adapted to changing formulas. This is of especially great importance for complicated and short-lived formulas and when there is an increasing number of raw materials. The dosing devices in the dosing tanks are preferably formed by dosing worms.

Advantageously, a cover is arranged at the top side of the dosing tank, so that it can be replaced automatically or manually.

According to another feature of the invention, the closing and dosing gates or the like of the dosing tank can be automatically activated. In this way, an automatic dosing of the powdery materials can be accomplished.

It is likewise advantageous that the covers of the dosing tanks can be automatically activated. The automatic activation can be pneumatic or electrical.

It is likewise advantageous for the dosing tanks to contain stirring mechanisms. Such stirring mechanisms preferably serve to remove all materials located in the dosing tank without a trace, so that essentially no material remains in the dosing tank. For this purpose, the dosing tank is preferably configured flat at its lower end.

The dosing tanks are preferably formed from a tank that is arranged inside a frame. The frame confers the necessary stability on the dosing tank and, moreover, offers possibilities of manipulation.

The tank can have a downward-tapering funnel shape. Thanks to this, the powder located inside is guided toward the gate at the bottom of the dosing tank.

The tank and frame advantageously have a rectangular horizontal projection. In this way, it becomes possible to arrange several dosing tanks in a row, making optimal use of the space.

If openings are provided at the bottom of the frame to accommodate the forks of a forklift truck or the like, the dosing tank can be easily transported with a corresponding forklift truck or the like.

As an alternative or in addition to this, the dosing tanks can have openings at their tops for insertion of a hoisting mechanism. This makes it possible to handle them by means of a crane.

Advantageously, four suspension devices are provided at each corner of the top side of the dosing tank. This enables lifting of the dosing tank by means of an appropriately configured X-shaped or rectangular lifting implement, without running the risk of the dosing tank swaying back and forth. In this way, a precise setting-down is possible. This, in turn, facilitates a fully automatic operation of the dosing layout.

For a partial duty or fully automatic duty, it is advantageous for the dosing tanks to have devices for identification. These can be formed, for example, by barcodes, which can be sensed by corresponding reading devices, or also by integrated circuits, which can be polled by corresponding transponders.

According to another feature of the invention, the dosing tanks have interfaces for connection to a control mechanism. These interfaces enable a polling of weighing devices in the dosing tanks, but also an activation of mechanisms located therein, such as mixing devices, dosing devices, or opening mechanisms for the cover or the gate.

Furthermore, it is advantageous for the dosing tanks to have mechanisms for connection to an electrical voltage supply, a pressurized air source, or the like, especially plug and socket connections. Through these plug-and-socket connections or slip-ring connections, the dosing tanks are supplied with the necessary energy at their corresponding positions, so that an operation of the dosing device or mixing device, as well as an automatic opening and closing of the cover and the gate, becomes possible.

The dosing device can contain a weighing mechanism, by which the material located in the dosing tank can be weighed. Various designs are possible for the weighing mechanism.

If at least one dosing mechanism is provided for a rough dosing and at least one dosing mechanism for a fine dosing, it is possible to accomplish a fast dosing, on the one hand, and a precise dosing on the other. For rather large quantities of the powdery material, the dosing mechanism for the rough dosing will be activated, and for the dosing of fine amounts the dosing mechanism for a fine dosing will then be activated and appropriately controlled.

The at-least two different mechanisms can be formed by two conveyor worms of different sizes.

The present invention will now be explained more closely by means of the enclosed drawings, which show sample embodiments of a dosing and mixing device, as well as details thereof.

These show:

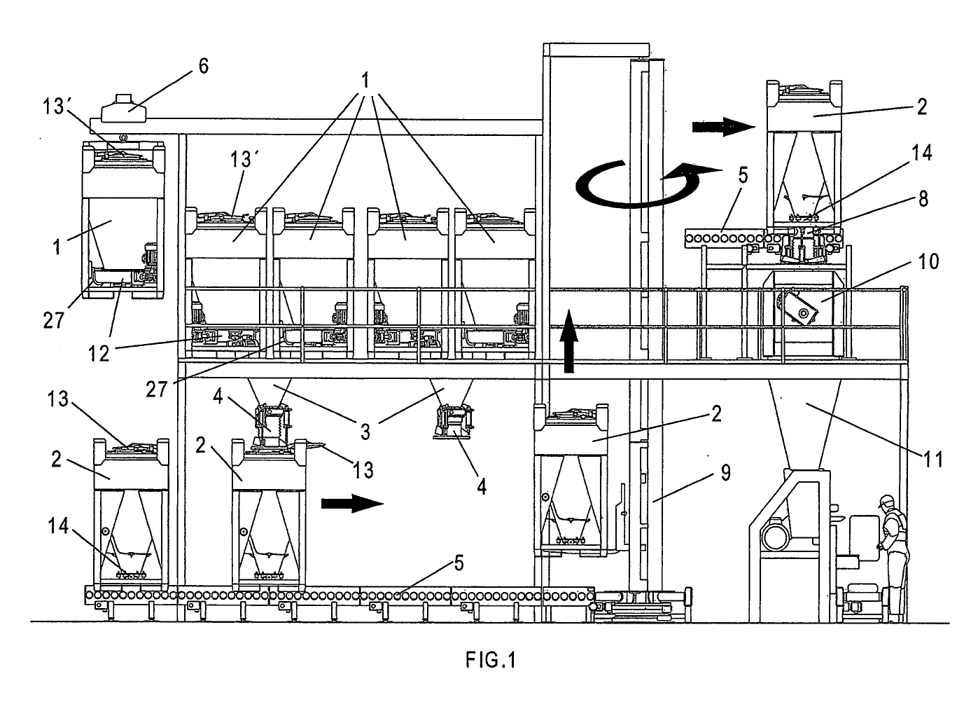

FIG. 1, a side view of a layout according to the invention for the dosing and mixing of powdery materials;

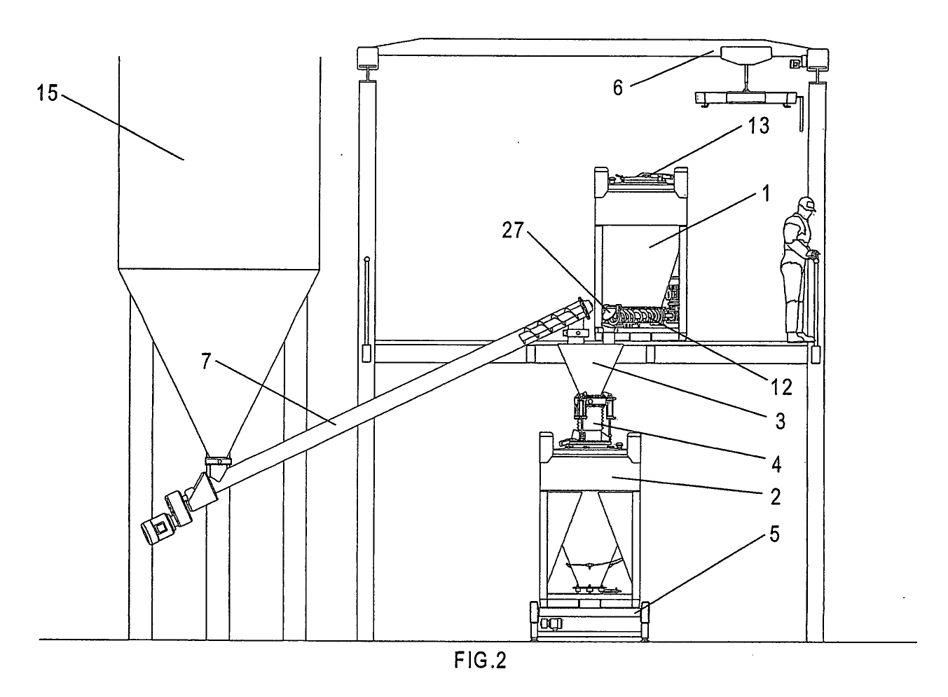

FIG. 2, a cross section representation of part of a dosing and mixing device with a large silo for large components;

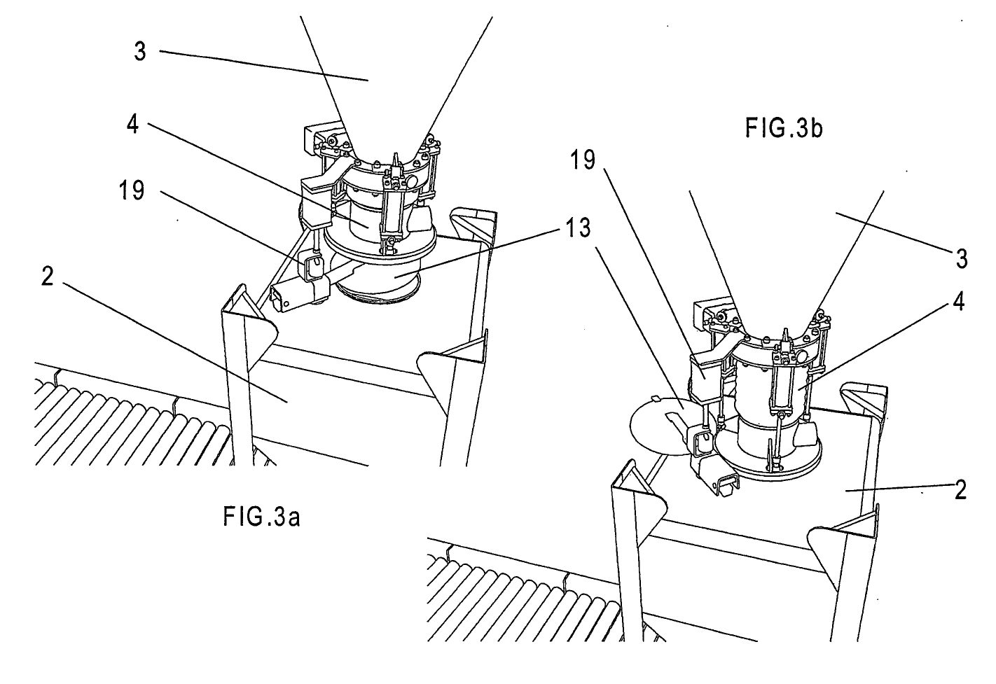

FIGS. 3a and 3b, a schematic view of the top side of a batch tank to illustrate the automatic cover opening;

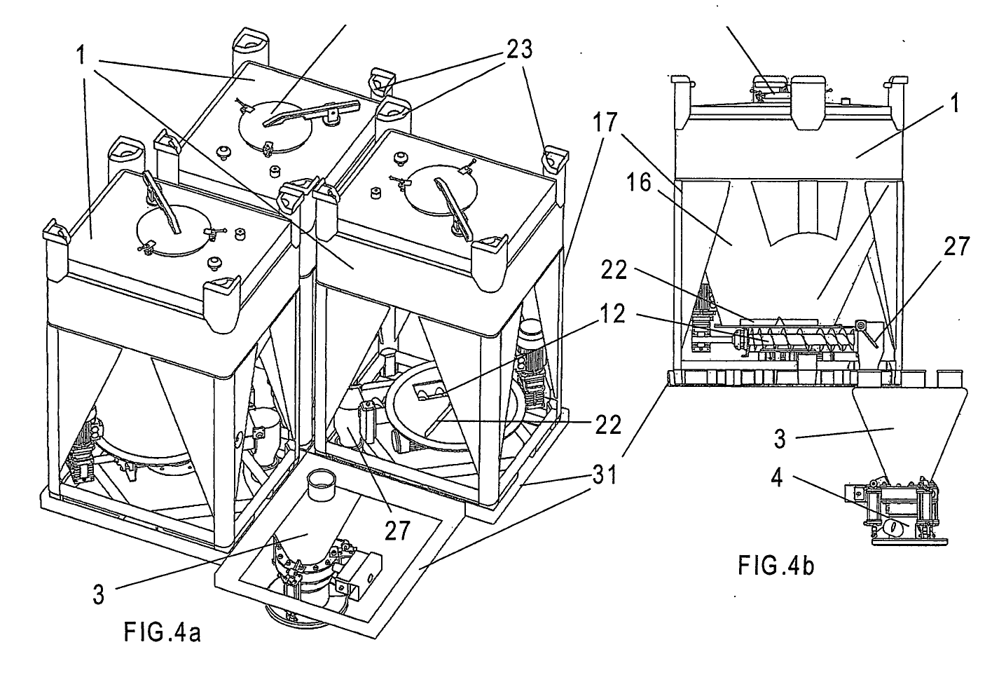

FIG. 4a, a perspective view in a partly cross-sectional dosing tank with dosing mechanism arranged therein;

FIG. 4b, a partly cross-sectional view through a dosing tank;

FIG. 4c, a cross-sectional view of one variant of a dosing tank with fine dosing;

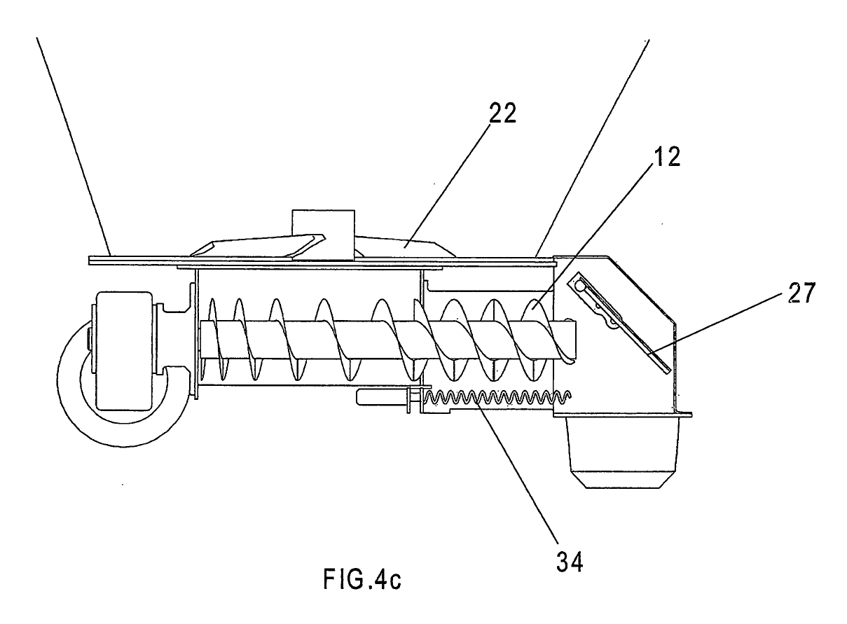

FIGS. 5a and 5b, a schematic view of a batch tank with automatically activated gate arranged therein;

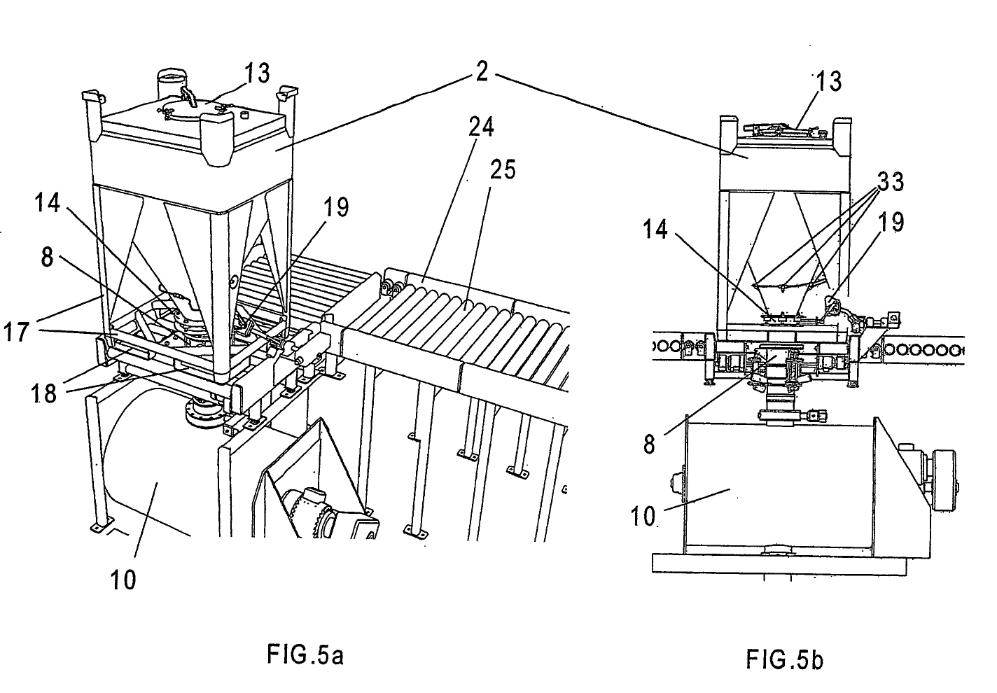

FIG. 6a, a perspective view of a mechanism for manual mixing-in materials;

FIG. 6b, a side view of the arrangement per FIG. 6a;

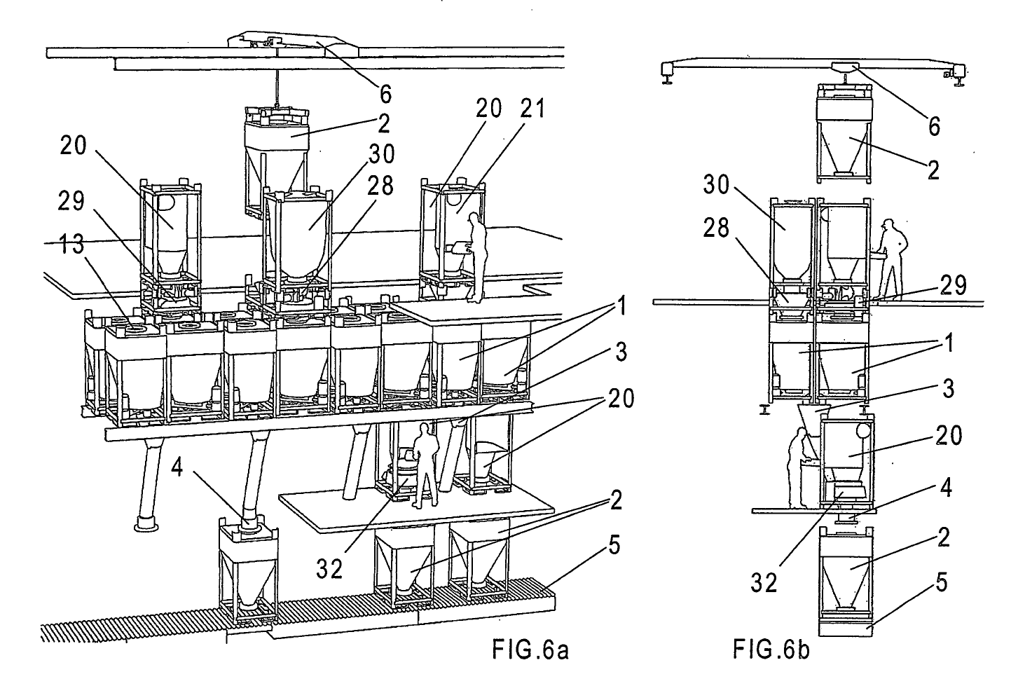

FIG. 7, a perspective schematic view of a minimal version of a dosing and mixing device; and

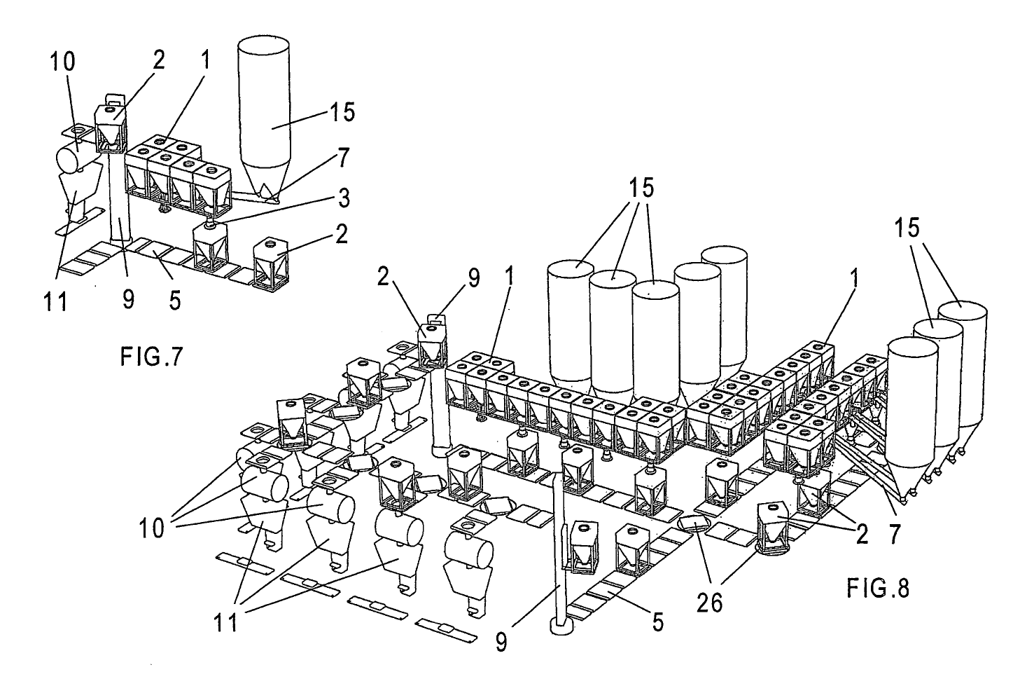

FIG. 8, a perspective schematic view of an expanded dosing and mixing layout.

FIG. 1 shows a side view of one embodiment of a dosing and mixing layout, in which several reservoirs configured as dosing tanks 1 are arranged essentially horizontally next to each other. The dosing tanks 1 contain the various powdery starting materials that are to be appropriately dosed and mixed. Beneath the dosing tank 1 is movably arranged at least one batch tank 2 to receive dosed amounts of starting materials from the dosing tanks 1. The movement of the batch tank 2 is achieved, for example, by a roller train 5. Beneath one or more dosing tanks 1 is arranged at least one collecting funnel 3 for collecting at least one starting material. By means of dosing mechanisms 12, which are integrated into the dosing tanks 1, definite quantities of starting materials are dispensed into the collecting funnel 3. In order to measure the desired quantity of starting material, a weighing mechanism can be integrated into the collecting funnel 3, or the dosing tanks 1 can be placed on individual weighing frames 31 (see FIGS. 4a and 4b). By using weighing mechanisms in the collecting funnel 3, the smallest of quantities are generally dosed with the highest of precision. By using the weighing frames 31 arranged underneath the dosing tanks 1, medium quantities of material are generally dosed with medium precision. The dosing by the weighing frame 31 occurs by a so-called subtractive weighing. Thanks to the fact that one weighing frame 31 is assigned to each dosing tank 1, a weighing of several products from several dosing tanks at the same time is possible. In this way, an especially large time savings is achieved, since the materials do not have to be dosed one after the other into the batch tank 2, as when weighing by means of the collecting funnel 3. The collecting funnel 3 is connected to a filling head 4 for filling the batch tank 2. Each of the batch tanks 2 has a cover 13 at its top end, and preferably the dosing tanks 1 also have covers 13′ at their top ends, which are preferably automatically activatable. At the lower end of the dosing tanks 1 is arranged a closing and dosing gate 27 or the like. After filling the batch tank 2 with corresponding amounts of starting materials of the dosing tanks 1, the former is transported further along the roller train 5 and taken to a mixing mechanism 10 by means of a lifting mechanism 9. The lifting mechanism 9 is preferably arranged so that it can turn 360 degrees. By the lifting mechanism 9, the respective batch tank 2 is again set down on a roller train 5 and then moved above the mixing mechanism 10. At the lower end of the batch tank 2 are gates 14, which are preferably automatically activated. By means of the mechanism 8 for dust-tight docking and for moving the gate 14 at the bottom end of the batch tank 2, the latter is opened, whereupon the powdery material located inside goes into the mixer 10 and is then handed off for further processing, for example, to a bagging installation 11. After emptying the batch tank 2, the latter is moved back via the roller train 5 to the lifting mechanism 9 and then arranged once more underneath the dosing tanks 1 for refilling or taken to a cleaning process. Above the dosing tanks 1, a transport mechanism such as a crane 6 can be arranged for moving the dosing tank 1 or for positioning of replenishing containers (see FIGS. 6a and 6b).

As already mentioned above, chain conveyors or the like can also be used instead of roller trains 5. Finally, constructions are also possible for delivering the batch tank 2 and/or dosing tank 1 that offer free floor space, in that the batch tank 2 and/or the dosing tank 1 are transported suspended (not shown). In this case, structures are arranged at the top end of the batch tank 2 and/or the dosing tank 1 that rest against an overhead conveyor. These conveyors can be designed as roller or pulley trains driven at one or both ends, or as chain conveyors.

FIG. 2 shows a cross section of part of a dosing and mixing layout, wherein a large silo 15 for powdery materials of large quantity and rather low dosing precision is arranged next to the dosing tanks 1. By a conveying and dosing mechanism 7, the powdery material is delivered from the large silo 15 into the collecting funnel 3. The material mixed in from the large silo 15 is taken up together with the material or materials from the dosing tank or tanks 1, or previously or subsequently to this, into the collecting funnel 3 and placed via the filling head 4 into the batch tank 2. The weighing-out of the material from the large silo 15 can be done by a weighing mechanism 25 at the roller train 5 directly into the batch tank 2 (see FIG. 5a). After this, the batch tank 2 is moved further along by the roller train 5.

FIGS. 3a and 3b show a perspective schematic view of the top end of a batch tank 2 with a corresponding cover 13. By the filling head 4, the cover 13 is lifted and then turned to the side, whereupon the filling head 4 docks at the opening of the batch tank 2 and the material located in the collecting funnel 3 is placed into the batch tank 2. Thus, an automatic opening of the cover 13 is possible.

FIG. 4a shows a schematic perspective view of several dosing tanks 1 arranged next to each other and FIG. 4a a cross-sectional representation of a dosing tank 1 and the collecting funnel 3 arranged underneath. According to a preferred embodiment of the dosing tank 1, it consists of a tank 16 which is arranged inside a frame 17. If the tank 16 and frame 17 have a rectangular or square shape in horizontal projection, an especially space-saving arrangement of the dosing tanks 1 next to each other is possible. Inside the dosing tank 1 there is integrated a dosing mechanism 12 in the form of a dosing worm, which takes the powdery material into the collecting funnel 3. In addition, a stirring mechanism 22 can be provided inside the dosing tank 1 to help in removing the material, so that the dosing tank 1 can be emptied without a trace. Furthermore, openings 23 are provided at the top end of the dosing tank 1 for inserting a lifting mechanism, enabling a manipulation of the dosing tank 1, but also the equally configured batch tank 2, by means of a crane. The lifting mechanism can be formed by a crane 6, as represented in FIG. 1, to which a platelike or X-shaped structure is connected, having hooks that can be inserted into the suspension openings 23 at the top end of the dosing tank and/or the batch tank 2. At the end of the dosing mechanism 12 is arranged a closing and dosing gate 27, which can preferably be activated automatically. The dosing tank 1 can be set down on a weighing frame 31, having a corresponding weighing device, so that the dosing of the material located in the dosing tank 1 can be detected by a subtractive weighing.

FIG. 4c shows a cross-sectional view of one variant of a dosing tank 1 with fine dosing. For this purpose, next to the dosing mechanism 12 in the form of a conveyor worm for the rough dosing, there is provided another dosing mechanism 34 in the form of a smaller conveyor worm. By actuating the dosing mechanism 12 for the rough dosing, a rather large quantity of the powdery material can be dosed via the closing and dosing gate 27. By using the dosing mechanism 34 for the fine dosing, the particular fine dosing of the powdery material is then accomplished.

FIG. 5a shows a perspective view and FIG. 5b a side view of a batch tank 2, with the gate 14 arranged inside. By means of an activating mechanism 19, the gate 14 can be automatically opened and closed again, so that the contents of the batch tank 2 can be emptied, for example, into a mixing mechanism 10. To assist in the emptying of the batch tank 2, pneumatic fluffing nozzles 33 can be provided, which loosen up the material present in the batch tank 2 by one or more puffs of compressed air and ensure a complete emptying via the gate 14. At the lower end of the frame 17 of the batch tank 2 or also the dosing tank 1 there are preferably arranged openings 18 to receive the forks of a forklift truck or the like, or the forks of the lifting mechanism 9. FIG. 5a shows one element 24 of the roller train 5, which has several rollers 25 to move the batch tank 2 and possibly also the dosing tank 1 onward. The rollers 25 can be connected to various drive units.

FIG. 6a shows a perspective view of the arrangement of mechanisms 20 for the manual mixing of materials and FIG. 6b a side view thereof. Such mechanisms 20 for manual mixing-in materials can be arranged above the dosing tanks 1, and can be configured in essentially the same design as the dosing tanks 1 and have an opening 21 preferably at the side. Through this opening 21, a manual mixing-in material into the dosing tank 1 can take place. An inspection screen 32 can also be arranged beneath the opening 21, in order to sift out any impurities. Likewise, replenishing containers 30 can also be provided for filling the dosing tanks 1, consisting for example of bags arranged in a frame. By using intermediate elements 28 without an inspection screen 32 or intermediate elements 29 with an inspection screen 32, these replenishing containers 30 or mechanisms 20 for manual mixing of materials will dock to the cover 13 of the dosing tank 1 and fill it. A crane 6 is used to manipulate the dosing tank 1, as well as the batch tank 2.

FIG. 7 shows a perspective schematic view of a minimal version of a dosing and mixing layout. In the example depicted, a total of six dosing tanks 1 are arranged essentially horizontally next to each other. Furthermore, a large silo 15 is provided, whose contents are delivered by a conveying and dosing mechanism 7 to a collecting funnel 3 underneath the dosing tank 1. Underneath the dosing tanks 1, the batch tanks 2 are movably arranged. For this purpose, a roller train 5 is used. The batch tank 2 can be taken by the roller train 5 to a lifting mechanism 9, which lifts the batch tank 2 filled with the corresponding powdery materials above a mixing mechanism 10, where the contents of the batch tank 2 can be discharged. After satisfactory blending of the powdery material, it can be taken to a bagging installation 11, for example. As already mentioned, the movement of the batch tank 2 and/or the dosing tank 1 can also be suspended from an overhead conveyor (not shown). In this case, either the lifting mechanism can rotate as a whole, or it contains a conveyor which can rotate. In such a system of an overhead conveyor, the filling head 4 that can be raised and lowered between the dosing tanks 1 and the batch tank 2 is arranged only once per batch tank 2 and can be integrated into the latter and travel with it along the movement track (not shown).

FIG. 8 shows an expanded configuration of the invention, in which a plurality of dosing tanks 1 and large silos 15 is arranged and in which the batch tanks 2 can be transported by corresponding roller trains 5 in a closed circuit in fully automated operation. Elements 26, which can turn, are used to achieve a change in direction on the roller trains 5. By two lifting mechanisms 9, the correspondingly filled batch tanks 2 can be lifted above corresponding mixing mechanisms 10, where they discharge their contents into the mixing mechanisms 10. After this, for example, the mixed powdery material is packaged in so-called bagging installations 11. The layout of the invention can be expanded especially easily and can thus be adapted to changes in the makeup of the components being dosed and mixed.

1-47. (canceled)

48. A device for dosing and mixing powdery materials during use, comprising reservoirs for starting materials arranged essentially horizontally next to each other, a closing and dosing gate at the lower end, dosing devices for dosing the materials during use, at least one mixing device, wherein beneath the reservoir at least one batch tank is movably arranged, comprising a cover at the upper end, to receive dispensed amounts of starting materials, while the batch tanks comprise a gate at the lower end, wherein the reservoirs are configured as dosing tanks and comprise integrated dosing devices.

49. The dosing and mixing device of claim 48, wherein the dosing tanks comprise covers at their upper ends.

50. The dosing and mixing device of claim 48, wherein the gates of the batch tanks and possibly the closing and dosing gates of the dosing tanks can be activated automatically during use.

51. The dosing and mixing device of claim 48, wherein the covers of the dosing tanks can be automatically activated during use.

52. The dosing and mixing device of claim 51, wherein the covers of the batch tanks can be automatically activated during use.

53. The dosing and mixing device of claim 48, comprising at least one collecting funnel arranged underneath one or more dosing tanks for collecting at least one starting material during use.

54. The dosing and mixing device of claim 53, comprising a filling head connected to the collecting funnel at the lower end for filling the batch tank during use.

55. The dosing and mixing device of claim 54, wherein the filling head comprises a device for activating the cover of the batch tank being filled during use.

56. The dosing and mixing device of claims 53, wherein the collecting funnel comprises a weighing device.

57. The dosing and mixing device of claims 48, comprising weighing frames, on which the dosing tanks can be placed during use.

58. The dosing and mixing device of claim 48, wherein the dosing tanks are arranged so that they can move along a predetermined path during use.

59. The dosing and mixing device of claim 48, comprising large silos for large components and further comprising conveying and dosing equipment for mixing the large components into the batch tank or collecting funnel manually during use.

60. The dosing and mixing device of claim 48, comprising devices for manual mixing-in materials during use, which are configured essentially identical in design to the dosing tanks and possibly to the batch tanks, comprising an opening for the mixing-in materials.

61. The dosing and mixing device of claim 48, wherein the dosing tanks comprise stirring mechanisms.

62. The dosing and mixing device of claim 48, wherein the movement paths of the batch tanks and/or the dosing tanks are composed of individual elements comprising conveying mechanisms.

63. The dosing and mixing device of claim 62, wherein the conveying mechanisms are rollers.

64. The dosing and mixing device of claim 62, wherein elements of the movement paths can pivot during use.

65. The dosing and mixing device of claim 62, wherein elements of the movement paths comprise weighing devices.

66. The dosing and mixing device of claim 48, comprising a transport device arranged above the dosing tank for the moving of the dosing tank and/or for the positioning of replenishment containers during use.

67. The dosing and mixing device of claim 48, wherein the dosing tanks and/or the batch tanks are formed from a tank which is arranged inside a frame.

68. The dosing and mixing device of claim 67, wherein the tank comprises a downward-tapering funnel shape.

69. The dosing and mixing device of claim 67, wherein the tank and the frame comprise rectangular horizontal projections.

70. The dosing and mixing device of claim 67, comprising openings at the bottom of the frame to accommodate the forks of a forklift truck.

71. The dosing and mixing device of claim 48, wherein the dosing tank and/or the batch tank comprise openings at their tops for insertion of a hoisting mechanism.

72. The dosing and mixing device of claim 71, comprising four suspension openings at each corner of the top side of the dosing tank and/or the batch tank.

73. The dosing and mixing device of claim 48, wherein the dosing tank and the batch tank have identical outer dimensions.

74. The dosing and mixing device of claim 48, comprising a lifting mechanism for lifting the batch tank and/or the dosing tank during use.

75. The dosing and mixing device of claim 74, wherein the lifting mechanism can be rotated 360 degrees during use.

76. The dosing and mixing device of claim 48, wherein the batch tank and/or the dosing tank comprises devices for identification.

77. The dosing and mixing device of claim 48, wherein the batch tank and/or the dosing tank comprises interfaces for connection to a control mechanism.

78. The dosing and mixing device of claim 48, wherein the batch tank and/or the dosing tank comprises mechanisms for connection to an electrical voltage supply and/or a pressurized air source.

79. The dosing and mixing device of claim 48, wherein the batch tanks move along an essentially closed path during use.

80. A device for the dosing of powdery materials, comprising a reservoir comprising a closing and dosing gate at the lower end, dosing devices for dosing the materials, wherein the reservoirs are configured as dosing tanks comprising integrated dosing devices.

81. The dosing device of claim 80, wherein a cover is at the top side of the dosing tank.

82. The dosing device of claim 80, wherein the closing and dosing gates can be automatically activated during use.

83. The dosing device of claim 80, wherein the cover can be automatically activated during use.

84. The dosing device of claim 80, wherein the dosing tanks contain stirring mechanisms.

85. The dosing device of claim 80, wherein the dosing tanks are formed from a tank, which is arranged inside a frame.

86. The dosing device of claim 85, wherein the tank comprises a downward-tapering funnel shape.

87. The dosing device of claim 85, wherein the tank and the frame comprise rectangular horizontal projections.

88. The dosing device of claim 85, comprising openings at the bottom of the frame that can accommodate forks of a forklift.

89. The dosing device of claim 80, wherein the dosing tanks comprise openings at their tops for insertion of a hoisting mechanism during use.

90. The dosing device of claim 89, comprising at least one suspension opening at each corner of the top side of the dosing tank.

91. The dosing device of claim 80, wherein the dosing tanks comprise devices for identification.

92. The dosing device of claim 80, wherein the dosing tanks comprise interfaces for connection to a control mechanism.

93. The dosing device of claim 80, wherein the dosing tanks comprise mechanisms for connection to an electrical voltage supply and/or a pressurized air source.

94. The dosing device of claim 93, further defined as comprising plug-and-socket connections.

95. The dosing device of claim 80, comprising a weighing mechanism.

96. The dosing device of claim 80, comprising at least one dosing mechanism for a rough dosing and at least one dosing mechanism for a fine dosing during use.

97. The dosing device of claim 96, wherein the dosing mechanisms are formed by two conveyor worms of different sizes.
